(19) United States
(12) Patent Application Publication
(10) Pub. No.: US 2026/0070546 A1
(43) Pub. Date: Mar. 12, 2026

(54) METHOD AND APPARATUS FOR PREDICTIVE BRAKING ON A NONPLANAR ROAD

(71) Applicants: THE REGENTS OF THE UNIVERSITY OF CALIFORNIA, Oakland, CA (US); BREMBO INSPIRATION LAB CORP., Sunnyvale, CA (US)

(72) Inventors: Francesco Borrelli, Berkeley, CA (US); Thomas David Fork, Lake Oswego, OR (US); Francesco Camozzi, Sunnyvale, CA (US); Xiao-Yu Fu, Mountain View, CA (US)

(73) Assignees: THE REGENTS OF THE UNIVERSITY OF CALIFORNIA, Oakland, CA (US); BREMBO INSPIRATION LAB CORP., Sunnyvale, CA (US)

(21) Appl. No.: 19/313,342

(22) Filed: Aug. 28, 2025

Related U.S. Application Data
(60) Provisional application No. 63/688,278, filed on Aug. 28, 2024.

(51) Int. Cl. B60W 30/12; B60W 10/04; B60W 10/18; B60W 10/20; B60W 30/14

(52) U.S. Cl. CPC B60W 30/12; B60W 10/04; B60W 10/18; B60W 10/20; B60W 30/143; B60W 2520/105; B60W 2520/26; B60W 2520/28; B60W 2540/10; B60W 2540/12

(57) ABSTRACT

A system and method for brake actuator control considering road geometry are described. In one implementation, the system and method constantly monitor the proper acceleration of the vehicle (i.e., without the effect of gravity), the maximum friction between all the tires and the road (road adherence), and the speeds and angles of the wheels. The proper acceleration is then used to determine the forces and moments being exerted at each wheel contact to the ground, and may use compensation from calibration memory to adapt for the unique dynamic loading characteristics of the vehicle (e.g., weight and how weight shifts in the suspension during acceleration). These resultant forces and moments are subtracted from the maximum forces and moments that can be exerted as determined by the road adherence, and converted into a measure of the maximum available braking and traction force taking into account the wheel speeds and angles.

### CROSS-REFERENCE TO RELATED APPLICATIONS

This application claims priority to, and the benefit of, U.S. provisional patent application Ser. No. 63/688,278 filed on Aug. 28, 2024, incorporated herein by reference in its entirety.

### STATEMENT REGARDING FEDERALLY SPONSORED RESEARCH OR DEVELOPMENT

### Not Applicable

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### A. Technical Field

The technology of this disclosure pertains generally to driver assistance systems in vehicles, and more particularly to predictive braking on a nonplanar road.

### B. Background Discussion

Nonplanar road geometry plays a major role in the behavior and safety of ground vehicles that operate in such environments. Operating limits vary in response to road adherence change while new effects arise, such as losing tire contact with the road surface when cresting a hill. Present day Advanced Driver Assistance Systems (ADAS) focus on the treatment of road geometry. and more specifically solutions for flat roads.

Approaches that consider more complicated geometries limit their considerations to road curvature, slope, and bank. These variables are not sufficient to describe roads with curved cross-sections and thus subsequent analysis of vehicle safety is simplified in existing literature. Some approaches ignore changes in vehicle orientation due to road slope and bank when assessing rollover and friction limits. Furthermore, centripetal effects, such as a vehicle driving over a crest or off-camber turn, are absent. Other approaches consider changes in the components of gravity on a vehicle due to slope, yet not considering bank angle, while weight distribution of the vehicle is not considered when analyzing rollover prevention.

Therefore, there is a need for a new active safety system for predictive braking on nonplanar roads which addresses these shortcomings in a systematic and general manner applicable to general, smooth nonplanar road surfaces.

### BRIEF SUMMARY

This disclosure describes an approach for “smart” braking, including an approach for predictive braking, of a four-wheeled vehicle on a nonplanar road. One aspect of the approach is a methodology to consider friction and road contact safety on general smooth road geometry. This is used to develop an active safety system to preemptively reduce vehicle speed for upcoming road geometry, such as off-camber turns. The approach may be used for human-driven or autonomous vehicles as demonstrated with a simulated ADAS scenario. Loss of control due to driver error on nonplanar roads can be mitigated by the disclosed approach.

More particularly, and by way of example and not of limitation, this disclosure describes systems and methods for brake actuator control while considering road geometry. In one implementation, a system and method constantly monitors the proper acceleration of the vehicle (i.e., without the effect of gravity), the maximum friction between all the tires and the road (road adherence), and the speeds and angles of the wheels. The proper acceleration is then used to determine the forces and moments being exerted at each wheel contact to the ground, and can utilize compensation from calibration memory to adapt for the unique dynamic loading characteristics of the vehicle (e.g., weight and the manner in which weight shifts in the suspension during acceleration). These resultant forces and moments are subtracted from the maximum forces and moments that can be exerted as determined by road adherence, and converted into a measure of the maximum available braking and traction force taking into account the wheel speeds and angles (i.e., by computing wheel slip and slip angle).

Further aspects of the technology described herein will be brought out in the following portions of the specification, wherein the detailed description is for the purpose of fully disclosing preferred embodiments of the technology without placing limitations thereon.

### BRIEF DESCRIPTION OF THE DRAWINGS

The technology described herein will be more fully understood by reference to the following drawings which are for illustrative purposes only:

FIG. 1 depicts a parametric road surface x^{p}, with coordinates s, y, and θ^{s} describing vehicle pose relative to the surface.

FIG. 2 shows wheelbase dimensions used for weight distribution.

FIG. 3A and FIG. 3B show vehicle trajectories on nonplanar U-turn, starting from bottom left.

FIG. 4A and FIG. 4B are a flowchart of an embodiment of an optimized non-planar surface controller process flow according to the present disclosure.

FIG. 5 is a block diagram of an embodiment of a vehicular implementation for optimized non-planar surface control according to the process flow shown in FIG. 4A and FIG. 4B.

FIG. 6A and FIG. 6B are a flowchart of an embodiment of an MPC safety planner controller process flow according to the present disclosure.

FIG. 7 is a block diagram of an embodiment of a vehicular implementation for MPC safety planner according to the process flow shown in FIG. 6A and FIG. 6B.

### DETAILED DESCRIPTION

### A. General Solution

This disclosure generally describes a system for brake actuator control considering road geometry. More particularly, the system is applicable to a vehicle with multiple (e.g., four) independently controlled brakes, one at approximately each corner of the vehicle, and with fully independent brake control. In one embodiment, the system constantly monitors the proper acceleration of the vehicle (that is, without the effect of gravity), the maximum friction between all the tires and the road (road adherence), as well as the speeds and angles of the wheels. The proper acceleration is then used to determine the forces and moments being exerted at each wheel contact to the ground, and may use compensation from calibration memory to adapt for the unique dynamic loading characteristics of the vehicle (e.g., its weight and how that weight shifts in the suspension during acceleration). These resultant forces and moments are subtracted from the maximum forces and moments that can be exerted as determined by road adherence, and converted into a measure of the maximum available braking and traction forces, while taking into account the wheel speeds and angles (i.e., by determining wheel slip and slip angle).

Meanwhile, in at least one embodiment the system also monitors the general vehicle state (especially velocity and acceleration in 3D) and control inputs to the vehicle (e.g., from the driver or autonomous driver) to determine if there is a request for any changes in the current state. If a change is detected, it can first optionally account for external dynamic forces, such as aerodynamic drag or tail wind. Then, it will take the requested change and the available brake and traction force as input into an optimizer that determines the output to each brake (notably, each brake on each wheel shall be separately controllable), as well as optionally controlling the steering and propulsive motor(s) or engine(s).

In particular, in at least one embodiment the optimizer will determine if a deceleration is required at any wheel, either due to a request to brake (brake request) or due to a need to maintain steering, such as determined through Electronic Stability Control (ESC) estimations. If so, the optimizer will determine the brake force and wheel slip request for each wheel, taking into account the previously determined brake force and traction as well as minimizing unrequested changes to the steering and/or angle of the vehicle. This distribution of braking force is then output to a brake controller that also maintains the desired wheel slip on each wheel. If available and required, the optimizer will also output a request to the propulsion system to increase, decrease, or apply negative throttle (i.e., regenerative braking) on all or a subset of the propulsion system. If available and required, the optimizer will also output a request to the steering controller or a driver steering indicator to alter the steering of the vehicle to maintain the originally desired vehicle state change request.

In one embodiment, various sensors on the vehicle and a driver interface are fed into the controller which executes the method that then communicates and maintains control via the vehicle actuators. The sensors can include, for example, wheel speed sensors on all wheels, angle sensors on the wheels responsible for steering, an Inertial Measurement Unit (IMU) to gather acceleration data, and a sensor for determining road adherence. The driver interface can include, for example, an accelerator pedal, a brake pedal, and a steering wheel. These are fed into the controller which interprets the information via a vehicle state detector, a wheel state detector, a road adherence detector, and a vehicle request detector. Additionally, a memory unit in the controller can provide previously recorded or computed calibration and weight information. A subset of the detectors are constantly updating the wheel traction calculator that actively maintains maximum available braking and traction force information. This outputs along with the remaining detectors to the brake distribution and actuation optimizer. The optimizer determines the requests and transmits them to the brake actuators, steering actuator, and throttle actuator. This figure notably does not highlight that the brake actuators are available for each wheel.

Various additional implementations may include without limitation the following:
(a) Steering may be available on additional wheels (e.g., 4 wheel steering) and thus have additional wheel angle sensors.
(b) The extent of road adherence can be obtained utilizing methods other than sensor based (e.g., computed via the wheel state detector or received via a communication interface).
(c) The driver interface can be adapted to an autonomous driver without physical pedal and wheel inputs.
(d) If not all of the vehicle actuators beyond the brakes are available, then, (i) instead of a steering actuator, an indicator could be used to signal the driver to temporarily alter steering input; and (ii) the propulsion throttle could be linked to all the wheels, or a subset of wheels, and can be separably controllable for all, or some of, the subset of wheels.

### B. Brake Control Method

### 1. Introduction

The disclosure that follows describes a predictive safety system and control method for safe vehicle operation on nonplanar road geometry, and demonstrates that the disclosed approach maintains safe vehicle speed on a simulated off-camber turn. The technology addresses gaps in current ADAS systems in the treatment of road geometry and provides an active safety system for predictive braking on nonplanar roads which addresses shortcomings in current approaches in a systematic and general manner applicable to general, smooth nonplanar road surfaces.

### 2. Vehicle Operating Limits

The disclosure considers three primary operating limits for a single-body vehicle on a smooth road surface: Tire friction, road contact, and velocity continuity. The last refers to the inability to instantly change vehicle speed, and is necessary to anticipate vehicle behavior on variable road geometry. To consider road geometry in a general sense a model is utilized, by way of example and not limitation, this is described as being the road model developed in Fork, T., Tseng, H. E., Borrelli, F., “Models for ground vehicle control on nonplanar surfaces”, Vehicle System Dynamics, pp. 1-25 (2023) (hereinafter Fork Models), which we introduce and use next.

### 2.1. Nonplanar Road Model

The Fork Models paper extends the approach of modeling a car as a body tangent to, and in contact with, a surface to a general parametric surface.

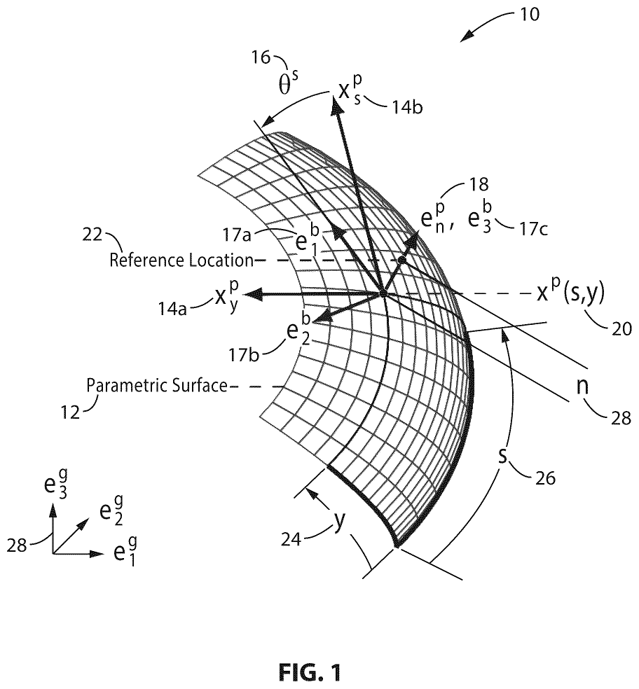

FIG. 1 is a diagram 10 that illustrates a parametric road surface x^{p} 12, with coordinates s 26, y 24,

$${x}_{y}^{p} 14 a , {x}_{s}^{p} 14 b ,$$

x^{p}(s, y) 20, reverence location 22, and θ^{s} 16 describing aspects of vehicle pose relative to the parametric road surface 12.

The road surface x^{p} 12 is parameterized by coordinates s and y, which then describe a vehicle positioned at normal offset n 28 from the road. Vehicle orientation is described by the angle θ^{s} 16 between the longitudinal vehicle axis

$${e}_{1}^{b} 17 a$$

(also shown is

$${e}_{2}^{b} 17 b and {e}_{3}^{b} 17 c , and {e}_{n}^{p} 18 )$$

and the s tangent vector 26 of the surface:

$${x}_{s}^{p} 14 b .$$

Surface coordinates may be chosen flexibly, such as to follow the center of a lane. The main results hold for any surface parameterization, and are:

$$[ \begin{matrix}\dot{s} \\ \dot{y}\end{matrix} ] {( I - nII )}^{- 1} J [ \begin{matrix}{v}_{1}^{b} \\ {v}_{2}^{b}\end{matrix} ] [ \begin{matrix}- {ω}_{2}^{b} \\ {ω}_{1}^{b}\end{matrix} ] = {J}^{- 1} {II ( I - nII )}^{- 1} J [ \begin{matrix}{v}_{1}^{b} \\ {v}_{2}^{b}\end{matrix} ] \qquad Equation 1$$

$${\dot{θ}}^{s} = {ω}_{3}^{b} \frac{( {x}_{ss}^{p} \times {x}_{s}^{p} ) \cdot {e}_{n}^{p}}{{x}_{s}^{p} \cdot {x}_{s}^{p}} \dot{s} + \frac{( {x}_{yy}^{p} \times {x}_{s}^{p} ) \cdot {e}_{n}^{p}}{{x}_{s}^{p} \cdot {x}_{s}^{p}} \dot{y}$$

Here

$${v}_{i}^{b} and {ω}_{i}^{b}$$

are the ISO body frame components of a vehicle's linear and angular velocity. I and II are the first and second fundamental forms of x^{p}, with partial derivatives of x^{p} denoted by subscripts. J is the Jacobian between the body frame and x^{p}, used here in the form of a Q-R decomposition:

$${θ}^{p} = - {sin}^{- 1} ( \frac{{x}_{s}^{p} \cdot {x}_{y}^{p}}{‖ {x}_{s}^{p} ‖ ‖ {x}_{y}^{p} ‖} ) Q = [ \begin{matrix}‖ {x}_{s}^{p} ‖ & 0 \\ - sin ( {θ}^{p} ) ‖ {x}_{y}^{p} ‖ & cos ( {θ}^{p} ) ‖ {x}_{y}^{p} ‖\end{matrix} ] \qquad Equation 2$$

$$J = [ \begin{matrix}{x}_{s}^{p} \cdot {e}_{1}^{b} & {x}_{s}^{p} \cdot {e}_{2}^{b} \\ {x}_{y}^{p} \cdot {e}_{1}^{b} & {x}_{y}^{p} \cdot {e}_{2}^{b}\end{matrix} ] = Q [ \begin{matrix}cos {θ}^{s} & - sin {θ}^{s} \\ sin {θ}^{s} & cos {θ}^{s}\end{matrix} ]$$

The Q-R form for J simplifies expressions in this disclosure, while Equation 1 captures nonplanar behavior. Coriolis forces and moments on the vehicle will follow from part of the Newton Euler equations:

$${F}_{1}^{b} = m ( {\dot{v}}_{1}^{b} - {ω}_{3}^{b} {v}_{2}^{b} ) {F}_{2}^{b} = m ( {\dot{v}}_{2}^{b} + {ω}_{3}^{b} {v}_{1}^{b} ) {F}_{3}^{b} = m ( {ω}_{1}^{b} {v}_{2}^{b} - {ω}_{2}^{b} {v}_{1}^{b} ) \qquad Equation 3$$

$${K}_{1}^{b} = {I}_{1}^{b} {\dot{ω}}_{1}^{b} + ( {I}_{3}^{b} - {I}_{2}^{b} ) {ω}_{2}^{b} {ω}_{3}^{b} {K}_{2}^{b} = {I}_{2}^{b} {\dot{ω}}_{2}^{b} + ( {I}_{1}^{b} - {I}_{3}^{b} ) {ω}_{3}^{b} {ω}_{1}^{b} \qquad Equation 4$$

$${v}_{3}^{b} = 0$$

per the Fork Models paper and thus is not present. For motion planning purposes, the disclosure exemplifies vehicle velocity using signed speed ν, sideslip angle β, and rates of change of θ^{s} and β proportional to ν as follows:

$${v}_{1}^{b} = v cos β {v}_{2}^{b} = v sin β {\dot{θ}}^{s} = {κ}^{s} v \dot{β} = {κ}^{β} v \qquad Equation 5$$

Expressions for

$${\dot{v}}_{1}^{b} and {\dot{v}}_{2}^{b}$$

follow via standard calculus. ν² and \dot{ν} will be decision variables in our safety system, with s, y, θ^{s}, β, κ^{s}, and κ^{β} treated as parameters. These choices will allow the disclosed safety system to be implemented as a convex optimization problem. Another result is an expression for

$${ω}_{3}^{b}$$

from \dot{θ}^{s} using Equation 1:

$${ω}_{3}^{b} = {κ}^{s} v - \frac{( {x}_{ss}^{p} \times {x}_{s}^{p} ) \cdot {e}_{n}^{p}}{{x}_{s}^{p} \cdot {x}_{s}^{p}} \dot{s} - \frac{( {x}_{yy}^{p} \times {x}_{s}^{p} ) \cdot {e}_{n}^{p}}{{x}_{s}^{p} \cdot {x}_{s}^{p}} \dot{y} \qquad Equation 6$$

### 2.2. Friction Cone Constraint

Using Equation 3, the constraint in the first line of Equation 1, and Equation 5, the net vehicle normal force is:

$${F}_{3}^{b} = {mv}^{2} [ cos ( β + {θ}^{s} ) sin ( β + {θ}^{s} ) ] {Q}^{- 1} {II ( I - nII )}^{- 1} Q [ \begin{matrix}cos ( β + {θ}^{s} ) \\ sin ( β + {θ}^{s} )\end{matrix} ] \qquad Equation 7$$

$${F}_{3}^{b}$$

is linear in ν², meaning the net normal tire force

$$( {F}_{3}^{t} )$$

is affine in ν² for a given s, y, and es θ^{s} gravity forces are constant (found in the Fork Models paper) and aerodynamic forces are often approximated as linear in ν².

Linear expressions for

$${F}_{1}^{b} and {F}_{2}^{b}$$

follow from the same equation blocks used to derive Eq. (7) and are not expanded here. As a result, net longitudinal and lateral tire forces

$${F}_{1}^{t} and {F}_{2}^{t}$$

are affine in \dot{ν} and ν² by the same assumptions. The complete friction cone constraint is then:

$${‖ {F}_{1}^{t} {F}_{2}^{t} ‖}_{2} \leq μ {F}_{3}^{t} \qquad Equation 8$$

where μ is a road adherence parameter. This constraint is a convex second order cone constraint as the tire forces are affine functions of \dot{ν} and ν².

### 2.3. Road Contact Constraint

Enforcing road contact requires modeling weight distribution, which requires modeling the roll and pitch moment on the vehicle. These follow from Equation 4, where the

$${ω}_{1 , 2 , 3}^{b}$$

coefficients are linear in ν due to the first line of Equation 1 and Equation 6. For

$${\dot{ω}}_{1 , 2}^{b}$$

the disclosure uses the approximation from the Fork Models paper that

$$[ \begin{matrix}- {\dot{ω}}_{2}^{b} \\ {\dot{ω}}_{1}^{b}\end{matrix} ] \approx {J}^{- 1} {II ( I - nII )}^{- 1} J [ \begin{matrix}{\dot{v}}_{1}^{b} \\ {v}_{2}^{b}\end{matrix} ] \qquad Equation 9$$

Expansion of Equation 4 using Equations 1, 5, 6 and 9, provides expressions for roll and pitch moments

$${K}_{1}^{b} and {K}_{2}^{b} .$$

These are linear in ν² and \dot{ν} and omitted for brevity. For weight distribution moments are considered from tire normal forces. The dominant source of other moments are longitudinal and lateral tire forces, which produce moments about the height of the center of mass h. Moments due to tire normal forces

$${K}_{1}^{N} and {K}_{2}^{N}$$

are then:

$${K}_{1}^{N} = {K}_{1}^{b} - {F}_{2}^{t} h {K}_{2}^{N} = {K}_{2}^{b} + {F}_{1}^{t} h \qquad Equation 10$$

These are affine in ν² and \dot{ν}, and may be extended to include ν² terms for aerodynamic moments.

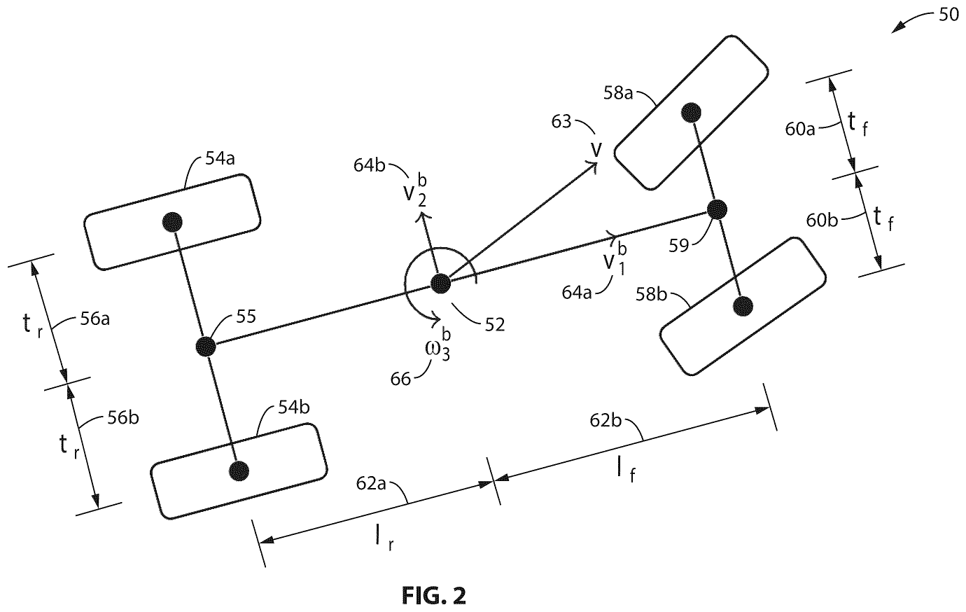

FIG. 2 illustrates wheelbase diagram 50, shown by way of example and not limitation with a first pair of wheels 54a, 54b, with rear tire track widths tᵣ 56a, 56b connected through a center 55, a second pair of wheels 58a, 58b with front tire track widths t_{f} 60a, 60b connected through a center 59, between centers 55 and 59 are wheelbase lengths lᵣ (length rear) 62a l_{f} (length front) 62b is shown with body center 52. Also shown is a velocity 63, with its components ν₁ 64a, and ν₂ 64b. Angular velocity

$${ω}_{3}^{b} 66$$

is also shown.

To model the forces on individual tires, the load-transfer model of Rucco, A., Notarstefano, G., Hauser, J., “Development and numerical validation of a reduced-order two-track car model”, European Journal of Control 20(4), 163-171 (2014):

$${N}_{f} = \frac{{F}_{3}^{t} {l}_{r} - {K}_{2}^{N}}{{l}_{r} + {l}_{f}} {N}_{r} = \frac{{F}_{3}^{t} {l}_{f} + {K}_{2}^{N}}{{l}_{r} + {l}_{f}} δ = \frac{{K}_{1}^{N}}{2 ( {t}_{f}^{2} + {t}_{r}^{2} )} \qquad Equation 11$$

$${N}_{fr} = {N}_{f} - δ {t}_{f} {N}_{fl} = {N}_{f} + δ {t}_{f} {N}_{rr} = {N}_{r} - δ {t}_{r} {N}_{rl} = {N}_{r} + δ {t}_{r}$$

The four tire normal forces N_{fr} (front right) through Nᵣₗ (rear left) are affine in ν² and \dot{ν}, meaning that constraining them to be positive to avoid loss of road contact is a convex constraint:

$${N}_{fr} \geq 0 {N}_{fl} \geq 0 {N}_{rr} \geq 0 {N}_{rl} \geq 0 \qquad Equation 12$$

### 2.4. Velocity Continuity Constraints

To develop the disclosed safety system, friction cone and road contact constraints are introduced at fixed points in space in a multistage control problem presented next. These stages must be connected together with velocity constraints relating ν² and ν at adjacent stages to capture vehicle speed changing over time. A midpoint integration scheme is used herein which is similar to that described by Verscheure, D., Demeulenaere, B., Swevers, J., De Schutter, J., Diehl, M., “Timeoptimal path tracking for robots: A convex optimization approach”, IEEE Transactions on Automatic Control 54(10), 2318-2327 (2009):

$${( {v}^{2} )}^{k + 1} = {( {v}^{2} )}^{k} + \frac{1}{2} ( {\dot{v}}^{k} + {\dot{v}}^{k + 1} ) ( {l}^{k + 1} - {l}^{k} ) \qquad Equation 13$$

Here superscript^{k} denotes the stage of the control problem, and l^{k} is the arc length traveled by a vehicle to reach stage k.

### 3. Active Safety System

An active safety system is developed with safety limits encoded by constraints of Equations 8, 12 and 13. These constraints are convex in ν² and \dot{ν} for fixed s, y, θ^{s}, β, κ^{s}, and κ^{β}, which are respectively made to be decision variables and parameters for the optimization problem below:

$${min}_{{( {v}^{2} )}^{k} , {\dot{v}}^{k}} {\sum }_{k = 0}^{N - 1} \vert {( {F}_{1}^{t} )}^{k} - B \vert \qquad Equation 14$$

$$Subject to Eq . ( 8 ) ∀ k$$

$$Eq . ( 12 ) ∀ k$$

$$Eq . ( 13 ) ∀ k$$

$${( {v}^{2} )}^{0} = {( {v}_{0} )}^{2}$$

Stages 0 through N−1 are introduced with decision variables and parameters present at each stage. Equation 13 constrains the speed between adjacent stages, while Equation 8 and Equation 12 constrain individual stages. Parameter ν₀ is introduced for initial speed of the vehicle, and B for a nominal brake force input. The objective function is used in the first line of Equation 14 which is the total absolute difference between B and the longitudinal tire force at each stage.

The main output of this optimization problem is

$${F}_{1}^{t} - B$$

at each stage, which informs how much tire forces must change relative to B for continued safe vehicle operation. As an example application, B could be a pedal request from a driver and

$${F}_{1}^{t} - B$$

being nonzero indicates active safety measures must be taken, such as an automated brake procedure. Minimizing

$${F}_{1}^{t} - B$$

corresponds to intervening only when necessary, such as if a driver fails to slow down for an off-camber turn.

It should be noted that the core novelty of this safety system disclosure is the nonplanar road safety constraints. These are not limited to speed-limiting applications, and may be used for active steering, suspension, and powertrain systems as well.

It should be appreciated that the proper acceleration coupled with independent calculation at each wheel allows for more granularity and accuracy than current standard approaches. The parametric surface strategy uniquely allows for the controller to manage fine-tuned compensations at each wheel while traversing non-planar roads, and for anticipating the consequence across the entire surface of the road; a flat system would likely struggle under more extreme effective slopes as first-order approximations break down, and it would be unable to anticipate accurately in a planer, as its conception of the flat road surface can't account in detail for all the future differently “slanted” flat surfaces needed (at each time point) to approximate the actual non-flat road behavior.

A simplified analogy is that of treating a curved road surface as a curve rather than flat, just as one might want to treat steering on a curved road or around a corner as a proper curve instead of a “flat” approach of cutting across in a straight line or a series of sharp-turns-and-straights to approximate the curve.

### 4. Simulation Environment

The active safety system of the present disclosure was tested using a simulated lane-keeping scenario on a nonplanar road surface. A nonplanar two-track vehicle model was utilized with suspension motion based on the Fork Models paper with a combined-slip Pacejka tire model based on Pacejka, H., “Tire and Vehicle Dynamics”, Butterworth-Heinemann, 3rd edn. (2012).

Driver behavior was simulated with a PI steering controller. Brake actuators and slip control were simulated with a proprietary Brembo model. The safety system was implemented as per Equation 14 with parameters for each stage corresponding to following the center of a lane, with brake force targets handled by a nonplanar Electronic Brakeforce Distribution (EBD) determination process as described below.

The core component of EBD is distributing a target brake force and moment over the four wheels of a car. This is fundamentally limited by the road adherence of each tire and any limits of the brake actuators. Weight distribution effects are considered in a general manner by careful use of accelerometer data. The raw output of any accelerometer is proper acceleration, which is related to coordinate acceleration in an inertial frame via gravitational acceleration g.

$${a}_{proper} = {a}_{coordinate} - g = \frac{1}{m} {F}^{b} - g \qquad Equation 15$$

The far-right expression follows from Newtonian mechanics, indicating that the accelerometer measures every force, except for gravity. This expression is used to estimate tire force components directly, which are used to compute the net normal force and moments in Equation 11. The four normal forces then inform the EBD algorithm, which distributes target net brake force and moment over the four wheels.

Two test cases were considered: First, impulsive brake application after an initial delay, modeling a delayed driver. Second, driver brake application was removed and the test repeated with the active safety system present. All simulations used the same steering control, brake control, vehicle simulator, and road surface: a U-turn with a 30% off-camber bank.

### 5. Results and Conclusion

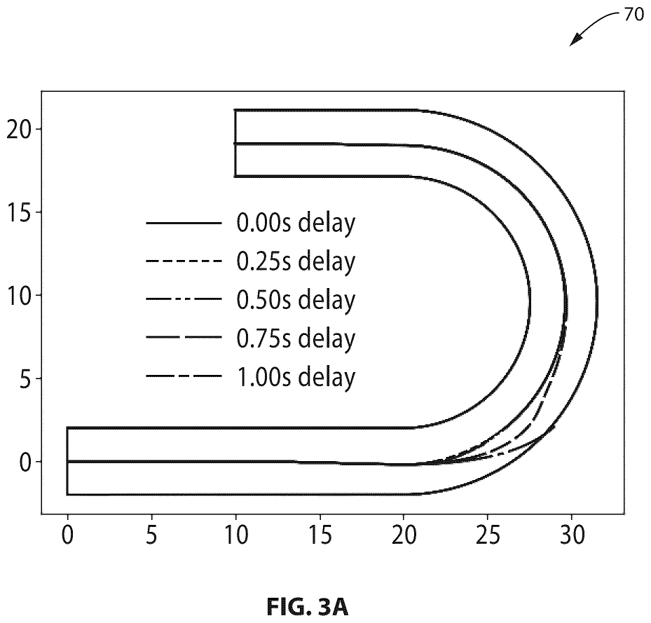

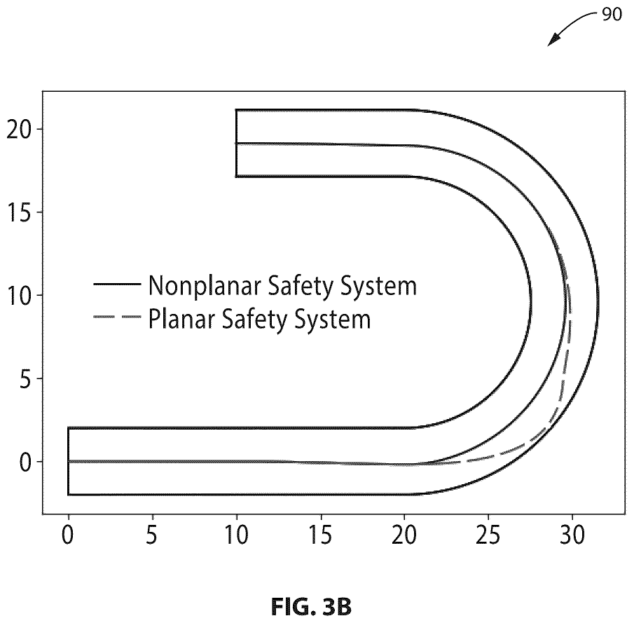

FIG. 3A and FIG. 3B illustrate 70, 90, closed loop vehicle trajectories with (FIG. 3A) and without (FIG. 3B) safety system. As evidenced in FIG. 3A, a proactive driver can maintain control of the vehicle, but must brake almost immediately to follow the lane. With the nonplanar safety system (FIG. 3B) no longitudinal driver intervention is necessary. However, implementation of the same system with a conventional planar road model results in loss of control. The safety system of the present disclosure mitigates loss of control of a vehicle using knowledge of the road surface and intended vehicle motion.

### 6. Example: Optimized Non-Planar Surface Controller

Following are described flowcharts and a vehicular implementation of the vehicular safety system for nonplanar road surfaces according to the present disclosure.

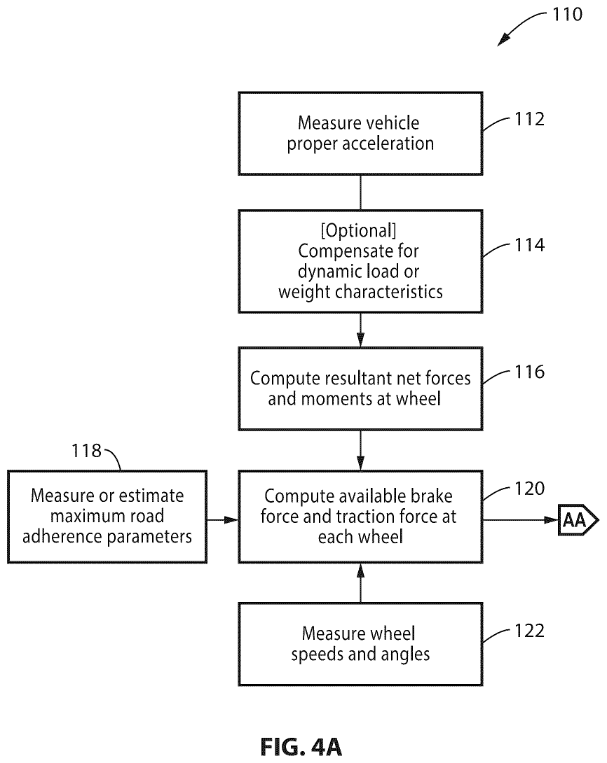

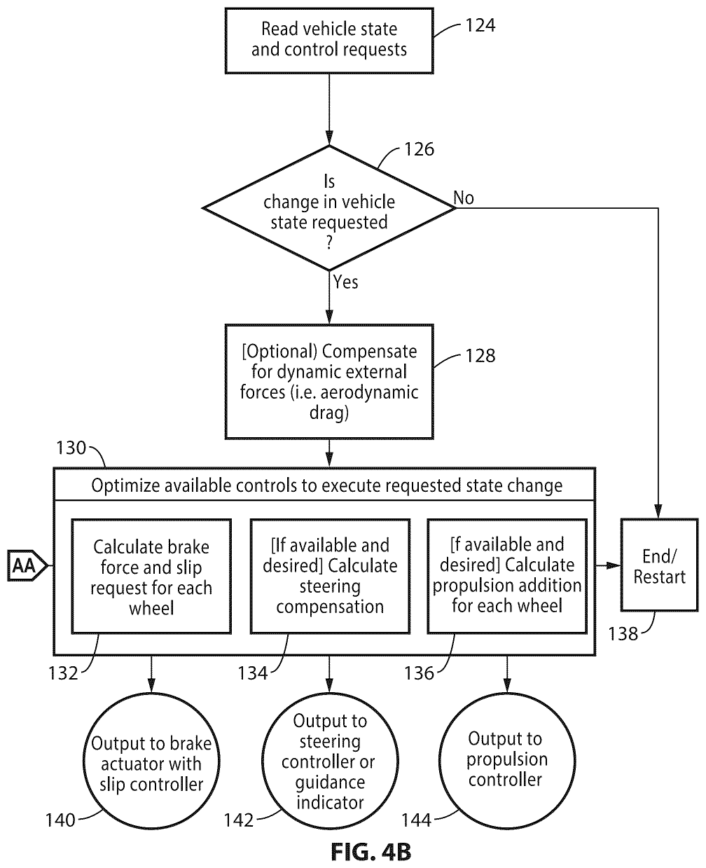

FIG. 4A and FIG. 4B is a flowchart 110 showing an embodiment of a control method for an optimized non-planar surface controller according to this disclosure.

As can be seen from the flowchart, the control method comprises the following steps. Measuring proper vehicle acceleration (PVA) of the vehicle at block 112 in FIG. 4A by reading the PVA from an inertial measurement unit (IMU). PVA is vehicle acceleration without the effect of gravity. Optionally, determining 114 compensation of the proper acceleration based on dynamics effects (weight and dynamic load, e.g., how heavy and how weight shifts in the suspension during acceleration). Determining resultant net forces 116 and moments being exerted at each wheel contact to the ground. Measuring or estimating 118 the maximum road adherence at each wheel, and the speed and steering angle of each wheel 122 which is input to determining 120 maximum available braking and traction forces on each wheel which is then input to block 130 in FIG. 4B.

Execution also begins in parallel at block 124 of FIG. 4B which monitors general vehicle state (especially velocity and acceleration in 3D) and inputs to the vehicle (e.g., from the driver or autonomous driver requests) and a determination made 126 if there is a request for change from the current state. If there are no changes, then execution moves to the End/Restart block 138. and continues to monitor for state requests.

Otherwise, a change has been detected and in block 128 optional compensation for dynamic external forces (e.g., aerodynamic drag or other factors that may contribute to the safety determination) is performed.

Then optimization 130 is performed with information received from block 120 of FIG. 4A to execute a requested state change. This involves computing with an optimization logic the new request for the actuation systems. In block 132 is seen the process of determining brake force and slip request for each independent wheel (e.g., each wheel that can be controlled independently) based on the request for change and the available brake and traction force as input. Then the action 140 is performed of outputting a signal to the brake actuator with slip controller. In particular, the optimizer determines if a deceleration is required at any independent wheel, either due to a request to brake (brake request) or due to a need to maintain steering such as computed via electronic stability control (ESC). The optimizer calculates the brake force and wheel slip request for each wheel, taking into account the previously computed brake force and traction as well as minimizing unrequested changes to the steering/angle of the vehicle. This distribution of braking force is then output to a brake controller that also maintains the desired wheel slip on each wheel.

Optional additional actions can be performed, which are shown by way of example and not limitation as follows.

Steering compensation can be determined 134, with an output 142 to the steering controller or guidance indicator. In this instance optimizer can output a request to the steering controller or a driver steering indicator to alter the steering of the vehicle to maintain the originally desired vehicle state change request.

Propulsion compensation can be performed directed to controlling propulsion motor(s) and/or engine(s) determined 136 for each wheel with an output generated to the propulsion controller. The optimizer outputs 144 a request to the propulsion system to increase, decrease, or apply negative throttle (i.e. regenerative braking) on all or a subset of the propulsion system.

After these outputs are generated then the process ends or in most cases restarts 138, since these optimizations are generally performed continuously while the vehicle is in motion.

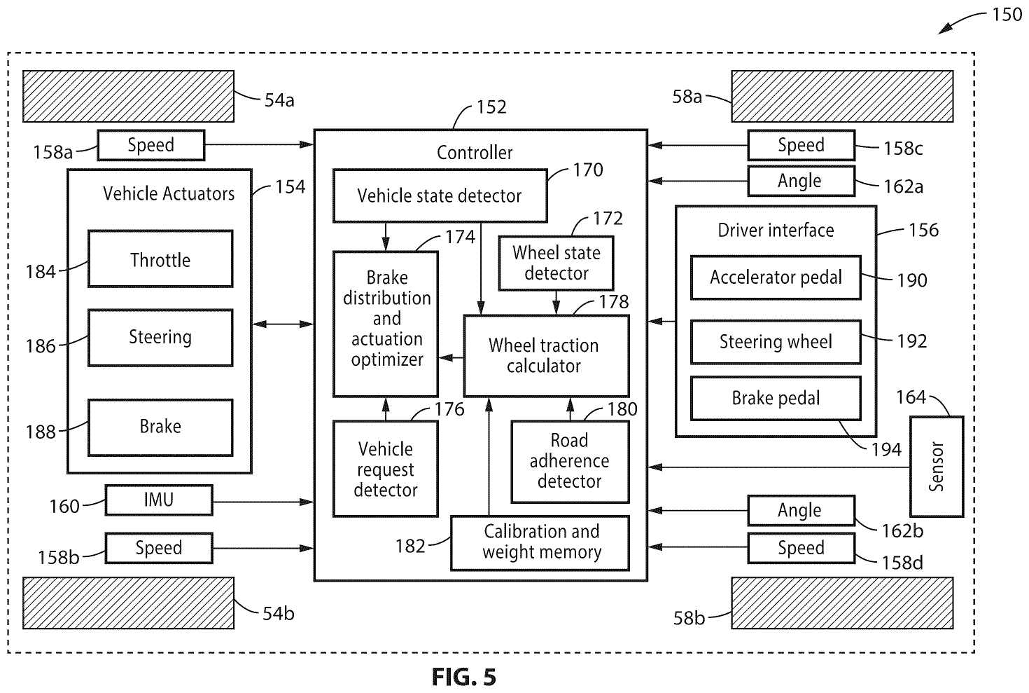

FIG. 5 illustrates 150 a vehicular implementation/configuration for optimized non-planar surface control according to the process flow shown in FIG. 4.

In the figure is shown numerous actuators, sensors, and controllers. The following provides an overview of the elements of the figure, and then the text goes into more detail about these elements.

The principle control blocks are a main controller 152, vehicle actuators 154 and a driver interface 156. Before moving into the sensors the figure shows multiple wheels 54a, 54b, 54c and 54d, four in this example, although it should be appreciated the present disclosure can be configured for controlling vehicles with any desired number of wheels.

Sensors are depicted with a wheel angular speed sensor 158a, 158b, 158c, and 158d for each wheel. Angle sensors 162a, 162b are shown for sensing the steering angle on each of the front wheels, although it can alternatively/optionally sense this at the steering column and optionally also on the rear axle.

An Inertial Measurement Unit (IMU) 160 is also shown, such as based on one or more sensors to measure the vehicle motion parameters, such as linear accelerations, rotational rates and orientation.

An environmental perception sensor 164 is shown which at least includes a road adherence sensor system (e.g., based on optical and/or acoustic and/or thermal sensing technology). It will be appreciated that a measure of road adherence can be obtained via other methods aside from a sensor (e.g., computed via the wheel state detector based on IMU and wheel speed sensors output or received via a communication interface).

A series of actuators 154 are exemplified, which are both controlled by and provide feedback to the controller, for controlling throttle 184, steering 186, and braking 188. It should be appreciated that despite the figure showing a single item for each element controlled, this does not mean they each are controlled by a single control input, as this depends on the complexity of the actuator being controlled, some may require numerous inputs to provide the desired level of control.

The distributed brake actuator(s) system 188, the steering actuator(s) system 186 and a throttle actuator(s) system 184, are namely powertrain actuators. All of these subsystems are intended as “smart actuators”, that are able to execute a request command and provide the state feedback to the controller 152. Notably, depending on the application and vehicle type not all of the vehicle actuators, beyond the brakes, may be available. Instead of a steering actuator, an indicator could be used to signal the driver to temporarily alter steering input, while the propulsion throttle could be linked to all or a subset of wheels and could be separably controllable for all or some subset of wheels. It should also be appreciated that depending on the application other forms of actuators may be controlled, without departing from the teachings of the present disclosure.

A driver interface 156 is shown for accepting inputs associated with an accelerator pedal 190, steering wheel 192, and brake pedal 194, each of these inputs being received by controller 152. Each of these inputs are simplified, as a single input, although each may comprise one or more related sensors. It should be noted that the driver interface can be adapted for control by an autonomous driver without physical pedals and wheel inputs.

The controller 152 comprises at least one computer processor (e.g., embedded computers, Application Specific Integrated Circuit (ASIC), or other real time processing circuitry) to process driving inputs, sensor inputs and controlling operation of the vehicle actuators based on the sensed information and the control method according to the present disclosure.

In this embodiment, the computer program instructions of controller 152 function for processing as a vehicle state detector 170, a wheel state detector 172, a brake distribution and actuation optimizer 174, a vehicle request detector 176, a wheel traction calculator 178, and a road adherence detector 180.

Additionally, a memory unit in the controller can provide previously recorded or computed calibration and weight information 182.

The pathways between the foregoing are illustrated in the figure. For example, vehicle state detector 170 provides inputs to both the brake distribution and actuation optimizer 174 and the wheel traction calculator 178. The wheel traction calculator 178 also receives inputs from wheel state detector 172, road adherence detector 180, and calibration and weight memory 182. Brake distribution and actuation optimizer 174 receives inputs from the vehicle state detector 170 and the vehicle request detector 176.

A subset of the detectors are constantly updating the wheel traction calculations that actively maintaining maximum available braking and traction force information. These outputs, along with the remaining detectors, provide information to the brake distribution and actuation optimizer. The optimizer computes the requests and transmits them to the brake actuators, steering actuator, and throttle actuator.

### 7. Example: MPC Safety Planner

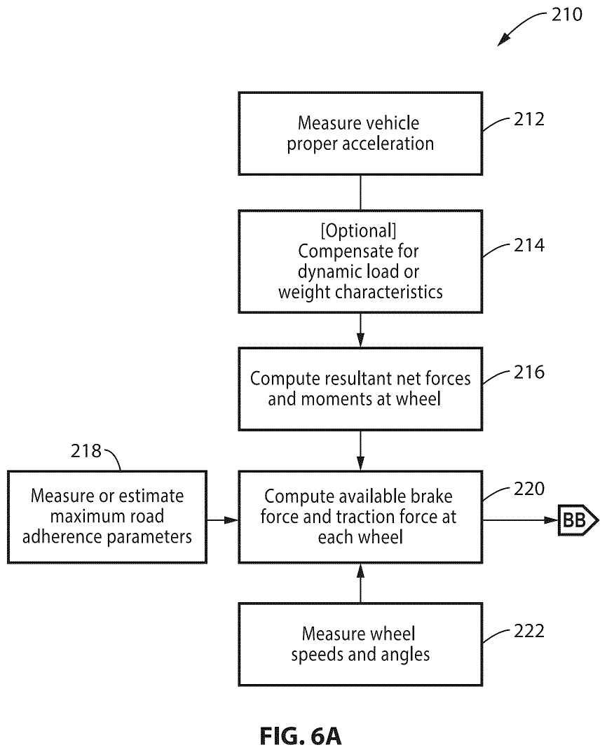

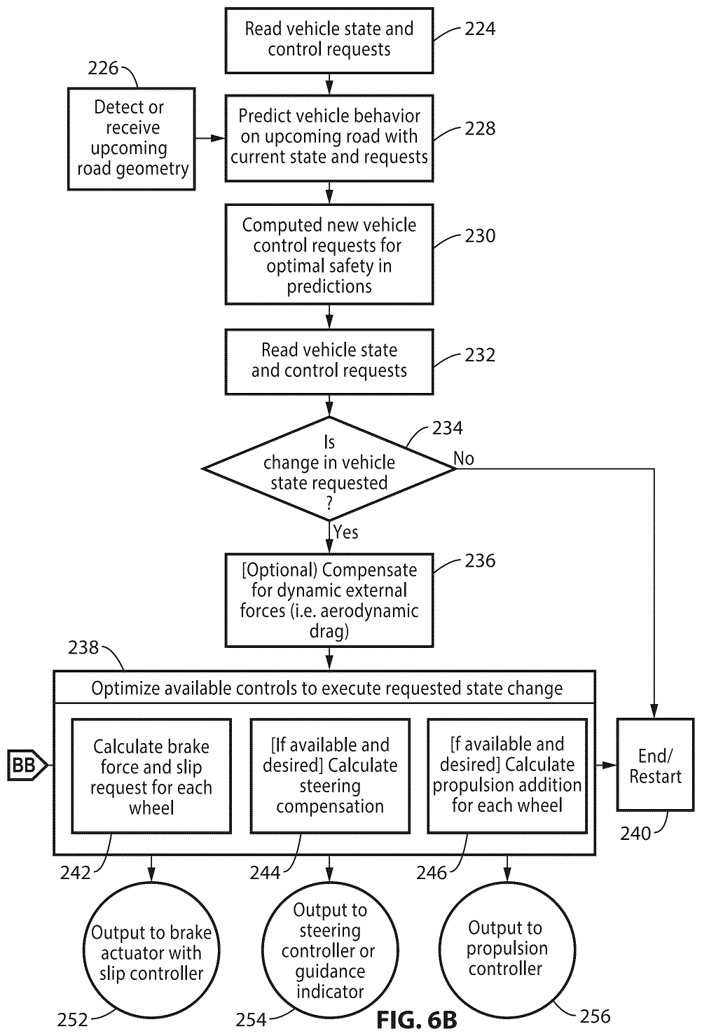

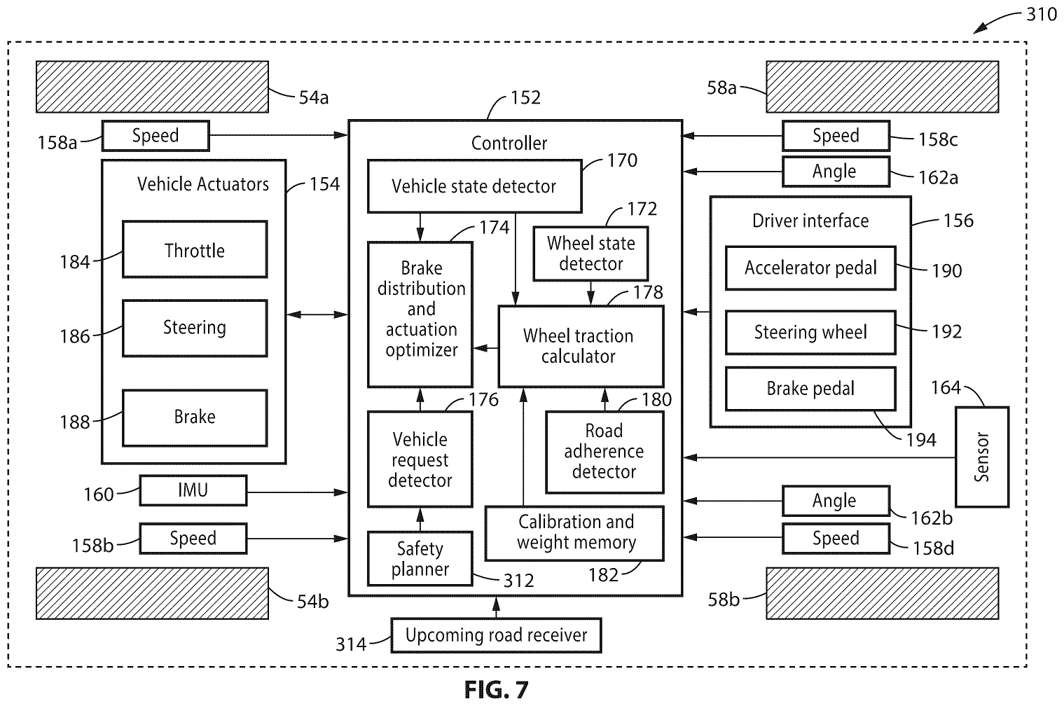

FIG. 6A and FIG. 6B illustrate a flowchart of an embodiment 210 for a MPC safety planner n control method according to this disclosure associated with FIG. 7 depicting a block diagram a corresponding vehicular implementation.

As can be seen from the flowchart, the control method comprises the following steps.

Measuring of Proper Vehicle Acceleration (PVA), 212 in FIG. 6A, of the vehicle by reading the PVA from an Inertial Measurement Unit (IMU) (or similar input(s) to arrive at that information). PVA indicates vehicle acceleration without a consideration of the effects of gravity. Then in block 214 is an optional step of compensating for proper acceleration based on dynamic effects (weight and dynamic load, e.g., how heavy and how weight shifts in the suspension during acceleration).

Execution moves to block 216 which determines net resultant forces and moments being exerted at each wheel making contact to the ground.

Measuring or estimating maximum road adherence at each wheel 218, and measuring wheel speeds and steering angles for each wheel 222, are combined along with that from block 216 being received at block 220 which determines available brake force and traction force at each wheel; with this information being directed to block 238 in FIG. 6B.

Execution also begins in parallel at block 224 where the system monitors general vehicle state (especially velocity and acceleration in 3D) and inputs to the vehicle (e.g., from the driver or autonomous driver requests) to determine if there is a request for change from the current state.

Then the system receives upcoming 3D road geometry 226 from the environmental sensing system or communication system, which is directed to block 228 that is a safety planner which predicts how the vehicle will follow a reference trajectory over the upcoming road geometry (for example, maintaining the current lane around a sloped bend) given the current state and any state change requests.

Then the safety planner determines 230 new state change requests to follow the reference trajectory while minimizing brake request changes, if necessary (for example, through an optimization around a prediction). Then at block 232 vehicle state and control requests are again evaluated in light of the potential update.

At decision block 234 it is determined if there is a resulting state change request. If there are no changes the system continue to monitor for state change requests, with execution moving to block 240 End/Restart.

If there are changes, the main controller is to be run for processing actions. First, the method can optionally account for external dynamic forces 236, such as aerodynamic drag or tail wind, according to the input request type.

The next steps are to optimize 238 available controls, as was seen in FIG. 4B, to execute a requested state change. This involves computing with an optimization logic the new request for the actuation systems based on the request for change and the available brake and traction force as input.

The output of this optimizer are at least the brake request for each independent wheel brake and optionally the request for the steering system and the propulsion motor(s) or engine(s). In particular, the optimizer will determine if a deceleration is required at any wheel, either due to a request to brake (brake request) or due to a need to maintain steering such as computed via electronic stability control (ESC).

In block 242 the optimizer determines a brake force and wheel slip request for each wheel, taking into account the previously computed brake force and traction as well as minimizing unrequested changes to the steering/angle of the vehicle. This distribution of braking force is then output 252 to a brake controller that also maintains the desired wheel slip on each wheel.

If available and required, the optimizer will also determine 244 steering compensation, and output 254 a request to the steering controller or a driver steering indicator to alter the steering of the vehicle to maintain the originally desired vehicle state change request.

If available and required, the optimizer will also determine 246 propulsion changes to increase, decrease, or apply negative throttle (i.e. regenerative braking) on all or a subset of the propulsion system, and output 256 these control signals to the propulsion controller.

After which the processing ends, or restarts 240, toward continued safety enhancement.

FIG. 7 illustrates a similar vehicular configuration, as was seen in FIG. 5, with only a couple differences. As with the optimized non-planar surface controller embodiment, the control method shown in FIG. 6A and FIG. 6B are implemented as, for example, computer program instructions performed by the controller.

This vehicle configuration also includes a safety planner 312 inputting to the vehicle request detector 176. The safety planner 312 is located in the controller for predicting the safest trajectory and it generates correction requests for the actuator systems.

An upcoming road receiver 314 is supported, which receives upcoming road geometry information based on 3D optical or acoustic sensing technology, and functions as an additional environmental perception sensor. The upcoming road geometry can be alternatively received, or augmented by, road geometry information obtained from other methods than a sensor (e.g., predicted based on the actual detected road state based on IMU sensors output or received via a communication interface).

### 8. General Scope of Implementations

From the description herein, it will be appreciated that the present disclosure encompasses multiple implementations of the technology which include, but are not limited to, the following:

An apparatus for braking and vehicle control on a nonplanar road, the apparatus comprising: (a) a group of sensors comprising a road adherence sensor, a wheel speed sensor, a wheel angle sensor, and inputs on accelerator pedal, steering wheel and braking; (b) an inertial measurement unit (IMU) comprising one or more sensors configured to measure vehicle motion; (c) a vehicle actuator system comprising a distributed brake actuator system with independent actuation of brake torque at each independent wheel; (d) a controller configured to receive vehicle operational signals from said group of sensors and said IMU while outputting signals to the vehicle actuator system; and (e) wherein said controller determines friction cone and road contact constraints at fixed points in space in a multistage control sequence in a modeling a car as a body tangent to and in contact with a general parametric surface, with each stage of the control sequence being connected together with velocity constraints at adjacent stages capturing vehicle speed changing over time with allowed operating limits varying in response to road adherence changes to preemptively reduce vehicle speed by generating signals to the vehicle actuator system to actuate sufficient braking levels to maintain the vehicle in its lane.

An apparatus for braking and vehicle control on a nonplanar road, the apparatus comprising: (a) a group of sensors comprising a road adherence sensor, a wheel speed sensor, a wheel angle sensor; (b) an inertial measurement unit (IMU) comprising one or more sensors configured to measure vehicle motion parameters, said vehicle motion parameters comprising one or more of vehicle linear acceleration, wheel rotational rate, and vehicle orientation; (c) a driver interface, said driver interface comprising one or more of an accelerator pedal, a brake pedal, a steering wheel, and one or more sensors associated with the accelerator pedal, brake pedal, and steering wheel; (d) a vehicle actuator system comprising a distributed brake actuator system with independent actuation of brake torque at each wheel and optionally at least one actuator selected from the group consisting of a steering actuator and a throttle actuator; (e) a controller configured to receive vehicle operational signals from said group of sensors, said IMU, said driver interface, said vehicle actuator system; (f) wherein said controller comprises a vehicle state detector, a brake distribution and actuation optimizer, a wheel state detector, a wheel traction calculator, a vehicle request detector, and a road adherence detector; (g) wherein said vehicle state detector outputs to said wheel traction calculator, wherein said wheel state detector outputs to said wheel traction calculator, wherein said road adherence detector outputs to said wheel traction calculator, wherein said vehicle state detector outputs to said brake distribution and actuation optimizer, wherein said wheel traction calculator outputs to said brake distribution and actuation optimizer, and wherein said vehicle request detector outputs to said brake distribution and actuation optimizer; and (h) wherein said brake distribution and actuation optimizer is configured to control operation of the vehicle actuator system as a function of said vehicle operational signals.

An apparatus for predictive braking and vehicle control on a nonplanar road, the apparatus comprising: (a) a group of sensors comprising a road adherence sensor, an upcoming road geometry sensor, a wheel speed sensor, a wheel angle sensor; (b) an inertial measurement unit (IMU) comprising one or more sensors configured to measure vehicle motion parameters, said vehicle motion parameters comprising one or more of vehicle linear acceleration, wheel rotational rate, and vehicle orientation; (c) a driver interface, said driver interface comprising one or more of an accelerator pedal, a brake pedal, a steering wheel, and one or more sensors associated with the accelerator pedal, brake pedal, and steering wheel; (d) a vehicle actuator system comprising a distributed brake actuator system with independent actuation of brake torque at each wheel and optionally at least one actuator selected from the group consisting of a steering actuator and a throttle actuator; (e) a controller configured to receive vehicle operational signals from said group of sensors, said IMU, said driver interface, said vehicle actuator system; (f) wherein said controller comprises a vehicle state detector, a brake distribution and actuation optimizer, a wheel state detector, a wheel traction calculator, a vehicle request detector, and a road adherence detector; (g) wherein said vehicle state detector outputs to said wheel traction calculator, wherein said wheel state detector outputs to said wheel traction calculator, wherein said road adherence detector outputs to said wheel traction calculator, wherein said vehicle state detector outputs to said brake distribution and actuation optimizer, wherein said wheel traction calculator outputs to said brake distribution and actuation optimizer, and wherein said vehicle request detector outputs to said brake distribution and actuation optimizer; (h) wherein said brake distribution and actuation optimizer is configured to control operation of the vehicle actuator system as a function of said vehicle operational signals; (i) wherein said controller is configured to receive signals from the upcoming road geometry sensor; and (j) wherein said controller further comprises a safety planner that receives signals from the upcoming road geometry sensor, predicts a safest vehicle trajectory, and outputs correction requests to the vehicle request detector.

A method for braking and vehicle control on a nonplanar road, the method comprising: (a) measure proper vehicle acceleration (PVA) of the vehicle by reading the PVA from an inertial measurement unit (IMU), wherein PVA is vehicle acceleration without the effect of gravity; (b) optionally, compute a compensation of the PVA based on dynamics effects such as vehicle weight and dynamic load; (c) compute resultant net forces and moments being exerted where each wheel contacts a ground surface; (d) measure or estimate the maximum road adherence at each wheel; (e) measure speed and steering angle of each wheel; (f) compute maximum available braking and traction force on each wheel; (g) monitor general vehicle state to determine if there is a request for change from current state; (h) enable optimized control logic in response to a request of state change, otherwise continue to monitor for state change requests; (i) if a change is detected, first optionally account for external dynamic forces such as aerodynamic drag or tail wind, according to the input request type; (j) compute a control signal to a vehicle actuation system based on a request for change and available brake and traction force as input; (k) output at least a brake request for each independent wheel brake and optionally a request for a steering system and a propulsion system; (I) determine if a deceleration is required at any wheel, either due to a request to brake (brake request) or due to a need to maintain steering such as computed via electronic stability control (ESC); (m) calculate a brake force and a wheel slip request for each wheel, taking into account the previously computed brake force and traction as well as minimizing unrequested changes to the steering/angle of the vehicle, and outputting this distribution of braking force is to a brake controller that also maintains desired wheel slip on each wheel; (n) if available and required, output a request to the propulsion system to increase, decrease, or apply negative throttle on all or a subset of a vehicle propulsion system; and (o) if available and required, output a request to a steering controller or a driver steering indicator to alter steering of the vehicle to maintain the originally desired vehicle state change request.

A method for predictive braking and vehicle control on a nonplanar road with a safety planner, the method comprising: (a) measure proper vehicle acceleration (PVA) of the vehicle by reading the PVA from an inertial measurement unit (IMU), wherein PVA is vehicle acceleration without the effect of gravity; (b) optionally, compute a compensation of the PVA based on dynamics effects such as vehicle weight and dynamic load; (c) compute resultant net forces and moments being exerted where each wheel contacts a ground surface; (d) measure or estimate the maximum road adherence at each wheel; (e) measure speed and steering angle of each wheel; (f) compute maximum available braking and traction force on each wheel; (g) monitor general vehicle state to determine if there is a request for change from current state; (h) receive upcoming 3D road geometry information; (i) predict how the vehicle will follow a reference trajectory over the upcoming road geometry; (j) compute new state change requests to follow the reference trajectory while minimizing brake request changes, if necessary; (k) enable optimized control logic in response to a request of state change, otherwise continue to monitor for state change requests; (I) if a change is detected, first optionally account for external dynamic forces such as aerodynamic drag or tail wind, according to the input request type; (m) compute a control signal to a vehicle actuation system based on a request for change and available brake and traction force as input; (n) output at least a brake request for each independent wheel brake and optionally a request for a steering system and a propulsion system; (o) determine if a deceleration is required at any wheel, either due to a request to brake (brake request) or due to a need to maintain steering such as computed via electronic stability control (ESC); (p) calculate a brake force and a wheel slip request for each wheel, taking into account the previously computed brake force and traction as well as minimizing unrequested changes to the steering/angle of the vehicle, and outputting this distribution of braking force is to a brake controller that also maintains desired wheel slip on each wheel; (q) if available and required, output a request to the propulsion system to increase, decrease, or apply negative throttle on all or a subset of a vehicle propulsion system; and (r) if available and required, output a request to a steering controller or a driver steering indicator to alter steering of the vehicle to maintain the originally desired vehicle state change request.

An apparatus for braking and vehicle control on a nonplanar road, the apparatus comprising: a group of sensors comprising a road adherence sensor, a wheel speed sensor, a wheel angle sensor; an inertial measurement unit (IMU) comprising one or more sensors configured to measure vehicle motion parameters, said vehicle motion parameters comprising one or more of vehicle linear acceleration, wheel rotational rate, and vehicle orientation; a driver interface, said driver interface comprising one or more of an accelerator pedal, a brake pedal, a steering wheel, and one or more sensors associated with the accelerator pedal, brake pedal, and steering wheel; a vehicle actuator system comprising a distributed brake actuator system with independent actuation of brake torque at each wheel and optionally at least one actuator selected from the group consisting of a steering actuator and a throttle actuator; a controller configured to receive vehicle operational signals from said group of sensors, said IMU, said driver interface, said vehicle actuator system; wherein said controller comprises a vehicle state detector, a brake distribution and actuation optimizer, a wheel state detector, a wheel traction calculator, a vehicle request detector, and a road adherence detector; wherein said vehicle state detector outputs to said wheel traction calculator, wherein said wheel state detector outputs to said wheel traction calculator, wherein said road adherence detector outputs to said wheel traction calculator, wherein said vehicle state detector outputs to said brake distribution and actuation optimizer, wherein said wheel traction calculator outputs to said brake distribution and actuation optimizer, and wherein said vehicle request detector outputs to said brake distribution and actuation optimizer; and wherein said brake distribution and actuation optimizer is configured to control operation of the vehicle actuator system as a function of said vehicle operational signals.

The apparatus or method any preceding or following implementation; further comprising a memory unit in the controller configured to output previously recorded or computed calibration and weight information to the wheel traction calculator.

The apparatus or method of any preceding or following implementation; further comprising said actuator configured for controlling throttle actuation, and said controller configured for modulating throttle responses in combination with braking to preemptively reduce vehicle speed.

The apparatus or method of any preceding or following implementation; further comprising said actuator configured for controlling steering actuation, and said controller configured for modulating steering responses in combination with braking toward maintaining the vehicle in its lane.

The apparatus or method of any preceding or following implementation; wherein the controller constantly updates the wheel traction calculator to actively maintain maximum available braking and traction force information; and wherein the brake distribution and actuation optimizer computes control signals and transmits the control signals to the brake actuator, and optionally to the steering actuator and the throttle actuator.

The apparatus or method of any preceding or following implementation; wherein said controller comprises a programmable processor and a non-transitory memory storing instructions executable by the processor; and wherein said instructions perform the functions of said vehicle state detector, said brake distribution and actuation optimizer, said wheel state detector, said wheel traction calculator, said vehicle request detector, and said road adherence detector.

The apparatus or method of any preceding or following implementation; wherein the controller constantly updates the wheel traction calculator to actively maintain maximum available braking and traction force information; and wherein the brake distribution and actuation optimizer computes control signals and transmits the control signals to the brake actuator, and optionally to the steering actuator and the throttle actuator.

The apparatus or method of any preceding or following implementation; wherein said controller comprises a programmable processor and a non-transitory memory storing instructions executable by the processor; and wherein said instructions perform the functions of said vehicle state detector, said brake distribution and actuation optimizer, said wheel state detector, said wheel traction calculator, said vehicle request detector, said road adherence detector, and said safety planner.

The apparatus or method of any preceding or following implementation; wherein the controller performs steps comprising: (a) measure proper vehicle acceleration (PVA) of the vehicle by reading the PVA from an inertial measurement unit (IMU), wherein PVA is vehicle acceleration without the effect of gravity; (b) optionally, compute a compensation of the PVA based on dynamics effects such as vehicle weight and dynamic load; (c) compute resultant net forces and moments being exerted where each wheel contacts a ground surface; (d) measure or estimate the maximum road adherence at each wheel; (e) measure speed and steering angle of each wheel; (f) compute maximum available braking and traction force on each wheel; (g) monitor general vehicle state to determine if there is a request for change from current state; (h) enable optimized control logic in response to a request of state change, otherwise continue to monitor for state change requests; (i) if a change is detected, first optionally account for external dynamic forces such as aerodynamic drag or tail wind, according to the input request type; (j) compute a control signal to a vehicle actuation system based on a request for change and available brake and traction force as input; (k) output at least a brake request for each independent wheel brake and optionally a request for a steering system and a propulsion system; (l) determine if a deceleration is required at any wheel, either due to a request to brake (brake request) or due to a need to maintain steering such as computed via electronic stability control (ESC); (m) calculate a brake force and a wheel slip request for each wheel, taking into account the previously computed brake force and traction as well as minimizing unrequested changes to the steering/angle of the vehicle, and outputting this distribution of braking force is to a brake controller that also maintains desired wheel slip on each wheel; (n) if available and required, output a request to the propulsion system to increase, decrease, or apply negative throttle on all or a subset of a vehicle propulsion system; and (o) if available and required, output a request to a steering controller or a driver steering indicator to alter steering of the vehicle to maintain the originally desired vehicle state change request.

An apparatus for braking and vehicle control on a nonplanar road, the apparatus comprising: a group of sensors comprising a road adherence sensor, a wheel speed sensor, a wheel angle sensor; an inertial measurement unit (IMU) comprising one or more sensors configured to measure vehicle motion parameters, said vehicle motion parameters comprising one or more of vehicle linear acceleration, wheel rotational rate, and vehicle orientation; a driver interface, said driver interface comprising one or more of an accelerator pedal, a brake pedal, a steering wheel, and one or more sensors associated with the accelerator pedal, brake pedal, and steering wheel; a vehicle actuator system comprising a distributed brake actuator system with independent actuation of brake torque at each wheel and optionally at least one actuator selected from the group consisting of a steering actuator and a throttle actuator; a controller configured to receive vehicle operational signals from said group of sensors, said IMU, said driver interface, said vehicle actuator system; wherein said controller comprises a vehicle state detector, a brake distribution and actuation optimizer, a wheel state detector, a wheel traction calculator, a vehicle request detector, and a road adherence detector; wherein said vehicle state detector outputs to said wheel traction calculator, wherein said wheel state detector outputs to said wheel traction calculator, wherein said road adherence detector outputs to said wheel traction calculator, wherein said vehicle state detector outputs to said brake distribution and actuation optimizer, wherein said wheel traction calculator outputs to said brake distribution and actuation optimizer, and wherein said vehicle request detector outputs to said brake distribution and actuation optimizer; and wherein said brake distribution and actuation optimizer is configured to control operation of the vehicle actuator system as a function of said vehicle operational signals.

The apparatus of any preceding or following implementation, further comprising a memory unit in the controller configured to output previously recorded or computed calibration and weight information to the wheel traction calculator.

The apparatus of any preceding or following implementation: wherein the controller constantly updates the wheel traction calculator to actively maintain maximum available braking and traction force information; and wherein the brake distribution and actuation optimizer computes control signals and transmits the control signals to the brake actuator, and optionally to the steering actuator and the throttle actuator.

The apparatus of any preceding or following implementation: wherein said controller comprises a programmable processor and a non-transitory memory storing instructions executable by the processor; and wherein said instructions perform the functions of said vehicle state detector, said brake distribution and actuation optimizer, said wheel state detector, said wheel traction calculator, said vehicle request detector, and said road adherence detector.

An apparatus for predictive braking and vehicle control on a nonplanar road, the apparatus comprising: a group of sensors comprising a road adherence sensor, an upcoming road geometry sensor, a wheel speed sensor, a wheel angle sensor; an inertial measurement unit (IMU) comprising one or more sensors configured to measure vehicle motion parameters, said vehicle motion parameters comprising one or more of vehicle linear acceleration, wheel rotational rate, and vehicle orientation; a driver interface, said driver interface comprising one or more of an accelerator pedal, a brake pedal, a steering wheel, and one or more sensors associated with the accelerator pedal, brake pedal, and steering wheel; a vehicle actuator system comprising a distributed brake actuator system with independent actuation of brake torque at each wheel and optionally at least one actuator selected from the group consisting of a steering actuator and a throttle actuator; a controller configured to receive vehicle operational signals from said group of sensors, said IMU, said driver interface, said vehicle actuator system; wherein said controller comprises a vehicle state detector, a brake distribution and actuation optimizer, a wheel state detector, a wheel traction calculator, a vehicle request detector, and a road adherence detector; wherein said vehicle state detector outputs to said wheel traction calculator, wherein said wheel state detector outputs to said wheel traction calculator, wherein said road adherence detector outputs to said wheel traction calculator, wherein said vehicle state detector outputs to said brake distribution and actuation optimizer, wherein said wheel traction calculator outputs to said brake distribution and actuation optimizer, and wherein said vehicle request detector outputs to said brake distribution and actuation optimizer; wherein said brake distribution and actuation optimizer is configured to control operation of the vehicle actuator system as a function of said vehicle operational signals; wherein said controller is configured to receive signals from the upcoming road geometry sensor; and wherein said controller further comprises a safety planner that receives signals from the upcoming road geometry sensor, predicts a safest vehicle trajectory, and outputs correction requests to the vehicle request detector.

The apparatus of any preceding or following implementation, further comprising a memory unit in the controller configured to output previously recorded or computed calibration and weight information to the wheel traction calculator.

The apparatus of any preceding or following implementation: wherein the controller constantly updates the wheel traction calculator to actively maintain maximum available braking and traction force information; and wherein the brake distribution and actuation optimizer computes control signals and transmits the control signals to the brake actuator, and optionally to the steering actuator and the throttle actuator.

The apparatus of any preceding or following implementation: wherein said controller comprises a programmable processor and a non-transitory memory storing instructions executable by the processor; and wherein said instructions perform the functions of said vehicle state detector, said brake distribution and actuation optimizer, said wheel state detector, said wheel traction calculator, said vehicle request detector, said road adherence detector, and said safety planner.

A method for braking and vehicle control on a nonplanar road, the method comprising: (a) measure proper vehicle acceleration (PVA) of the vehicle by reading the PVA from an inertial measurement unit (IMU), wherein PVA is vehicle acceleration without the effect of gravity; (b) optionally, compute a compensation of the PVA based on dynamics effects such as vehicle weight and dynamic load; (c) compute resultant net forces and moments being exerted where each wheel contacts a ground surface; (d) measure or estimate the maximum road adherence at each wheel; (e) measure speed and steering angle of each wheel; (f) compute maximum available braking and traction force on each wheel; (g) monitor general vehicle state to determine if there is a request for change from current state; (h) enable optimized control logic in response to a request of state change, otherwise continue to monitor for state change requests; (i) if a change is detected, first optionally account for external dynamic forces such as aerodynamic drag or tail wind, according to the input request type; (j) compute a control signal to a vehicle actuation system based on a request for change and available brake and traction force as input; (k) output at least a brake request for each independent wheel brake and optionally a request for a steering system and a propulsion system; (l) determine if a deceleration is required at any wheel, either due to a request to brake (brake request) or due to a need to maintain steering such as computed via electronic stability control (ESC); (m) calculate a brake force and a wheel slip request for each wheel, taking into account the previously computed brake force and traction as well as minimizing unrequested changes to the steering/angle of the vehicle, and outputting this distribution of braking force is to a brake controller that also maintains desired wheel slip on each wheel; (n) if available and required, output a request to the propulsion system to increase, decrease, or apply negative throttle on all or a subset of a vehicle propulsion system; and (o) if available and required, output a request to a steering controller or a driver steering indicator to alter steering of the vehicle to maintain the originally desired vehicle state change request.

A method for predictive braking and vehicle control on a nonplanar road with a safety planner, the method comprising: (a) measure proper vehicle acceleration (PVA) of the vehicle by reading the PVA from an inertial measurement unit (IMU), wherein PVA is vehicle acceleration without the effect of gravity; (b) optionally, compute a compensation of the PVA based on dynamics effects such as vehicle weight and dynamic load; (c) compute resultant net forces and moments being exerted where each wheel contacts a ground surface; (d) measure or estimate the maximum road adherence at each wheel; (e) measure speed and steering angle of each wheel; (f) compute maximum available braking and traction force on each wheel; (g) monitor general vehicle state to determine if there is a request for change from current state; (h) receive upcoming 3D road geometry information; (i) predict how the vehicle will follow a reference trajectory over the upcoming road geometry; (j) compute new state change requests to follow the reference trajectory while minimizing brake request changes, if necessary; (k) enable optimized control logic in response to a request of state change, otherwise continue to monitor for state change requests; (l) if a change is detected, first optionally account for external dynamic forces such as aerodynamic drag or tail wind, according to the input request type; (m) compute a control signal to a vehicle actuation system based on a request for change and available brake and traction force as input; (n) output at least a brake request for each independent wheel brake and optionally a request for a steering system and a propulsion system; (o) determine if a deceleration is required at any wheel, either due to a request to brake (brake request) or due to a need to maintain steering such as computed via electronic stability control (ESC); (p) calculate a brake force and a wheel slip request for each wheel, taking into account the previously computed brake force and traction as well as minimizing unrequested changes to the steering/angle of the vehicle, and outputting this distribution of braking force is to a brake controller that also maintains desired wheel slip on each wheel; (q) if available and required, output a request to the propulsion system to increase, decrease, or apply negative throttle on all or a subset of a vehicle propulsion system; and (r) if available and required, output a request to a steering controller or a driver steering indicator to alter steering of the vehicle to maintain the originally desired vehicle state change request.

The apparatus of any of preceding implementation where the controller performs the method steps of any preceding implementation.

Embodiments of the technology of this disclosure may be described herein with reference to flowchart illustrations of methods and systems according to embodiments of the technology. Embodiments of the technology of this disclosure may also be described with reference to procedures, algorithms, steps, operations, formulae, or other computational depictions, which may be included within the flowchart illustrations or otherwise described herein. It will be appreciated that any of the foregoing may also be implemented as computer program instructions. In this regard, each block or step of a flowchart, and combinations of blocks (and/or steps) in a flowchart, as well as any procedure, algorithm, step, operation, formula, or computational depiction can be implemented by various means, such as hardware, firmware, and/or software including one or more computer program instructions embodied in computer-readable program code. As will be appreciated, any such computer program instructions may be executed by one or more computer processors, including without limitation a general purpose computer or special purpose computer, or other programmable processing apparatus to produce a machine, such that the computer program instructions which execute on the computer processor(s) or other programmable processing apparatus create means for implementing the function(s) specified.

Accordingly, blocks of the flowcharts, and procedures, algorithms, steps, operations, formulae, or computational depictions described herein support combinations of means for performing the specified function(s), combinations of steps for performing the specified function(s), and computer program instructions, such as embodied in computer-readable program code logic means, for performing the specified function(s). It will also be understood that each block of the flowchart illustrations, as well as any procedures, algorithms, steps, operations, formulae, or computational depictions and combinations thereof described herein, can be implemented by special purpose hardware-based computer systems which perform the specified function(s) or step(s), or combinations of special purpose hardware and computer-readable program code.

Furthermore, these computer program instructions, such as embodied in computer-readable program code, may also be stored in one or more computer-readable memory or memory devices that can direct a computer processor or other programmable processing apparatus to function in a particular manner, such that the instructions stored in the computer-readable memory or memory devices produce an article of manufacture including instruction means which implement the function specified in the block(s) of the flowchart(s). The computer program instructions may also be executed by a computer processor or other programmable processing apparatus to cause a series of operational steps to be performed on the computer processor or other programmable processing apparatus to produce a computer-implemented process such that the instructions which execute on the computer processor or other programmable processing apparatus provide steps for implementing the functions specified in the block(s) of the flowchart(s), procedure(s) algorithm(s), step(s), operation(s), formula (e), or computational depiction(s).

It will further be appreciated that the terms “programming” or “program executable” as used herein refer to one or more instructions that can be executed by one or more computer processors to perform one or more functions as described herein. The instructions can be embodied in software, in firmware, or in a combination of software and firmware. The instructions can be stored local to the device in non-transitory media, or can be stored remotely such as on a server, or all or a portion of the instructions can be stored locally and remotely. Instructions stored remotely can be downloaded (pushed) to the device by user initiation, or automatically based on one or more factors.

It will further be appreciated that as used herein, the terms controller, microcontroller, processor, microprocessor, hardware processor, computer processor, central processing unit (CPU), and computer are used synonymously to denote a device capable of executing the instructions and communicating with input/output interfaces and/or peripheral devices, and that the terms controller, microcontroller, processor, microprocessor, hardware processor, computer processor, CPU, and computer are intended to encompass single or multiple devices, single core and multicore devices, and variations thereof.

As used herein, the term “implementation” is intended to include, without limitation, embodiments, examples, or other forms of practicing the technology described herein.

As used herein, the singular terms “a,” “an,” and “the” may include plural referents unless the context clearly dictates otherwise. Reference to an object in the singular is not intended to mean “one and only one” unless explicitly so stated, but rather “one or more.”

Phrasing constructs, such as “A, B and/or C”, within the present disclosure describe where either A, B, or C can be present, or any combination of items A, B and C. Phrasing constructs indicating, such as “at least one of” followed by listing a group of elements, indicates that at least one of these groups of elements is present, which includes any possible combination of the listed elements as applicable.

References in this disclosure referring to “an embodiment”, “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system, or method.

As used herein, the term “set” refers to a collection of one or more objects. Thus, for example, a set of objects can include a single object or multiple objects.

Relational terms such as first and second, top and bottom, upper and lower, left and right, topside and underside, front and back, proximal and distal, leading and trailing, and the like, may be used solely to distinguish one entity, action, or orientation from another entity, action, or orientation without necessarily requiring or implying any actual such relationship or order between such entities, actions, or orientations. Such terms are not intended to be terms of limitation read into the claims.

The terms “comprises,” “comprising,” “has”, “having,” “includes”, “including,” “contains”, “containing” or any other variation thereof, are intended to cover a non-exclusive inclusion, such that a process, method, article, apparatus, or system, that comprises, has, includes, or contains a list of elements does not include only those elements but may include other elements not expressly listed or inherent to such process, method, article, apparatus, or system. An element proceeded by “comprises . . . a”, “has . . . a”, “includes . . . a”, “contains . . . a” does not, without more constraints, preclude the existence of additional identical elements in the process, method, article, apparatus, or system, that comprises, has, includes, contains the element.

As used herein, the terms “approximately”, “approximate”, “substantially”, “substantial”, “essentially”, and “about”, or any other version thereof, are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

The term “coupled” as used herein is defined as connected, although not necessarily directly and not necessarily mechanically. A device or structure that is “configured” in a certain way is configured in at least that way, but may also be configured in ways that are not listed.

Benefits, advantages, solutions to problems, and any element(s) that may cause any benefit, advantage, or solution to occur or become more pronounced are not to be construed as a critical, required, or essential feature or element of the technology described herein or any or all the claims.

In addition, in the foregoing disclosure various features may be grouped together in various embodiments for the purpose of streamlining the disclosure. This method of disclosure is not to be interpreted as reflecting an intention that the claimed embodiments require more features than are expressly recited in each claim. Inventive subject matter can lie in less than all features of a single disclosed embodiment.

The abstract of the disclosure is provided to allow the reader to quickly ascertain the nature of the technical disclosure. It is submitted with the understanding that it will not be used to interpret or limit the scope or meaning of the claims.

It will be appreciated that the practice of some jurisdictions may require deletion of one or more portions of the disclosure after the application is filed. Accordingly, the reader should consult the application as filed for the original content of the disclosure. Any deletion of content of the disclosure should not be construed as a disclaimer, forfeiture, or dedication to the public of any subject matter of the application as originally filed.

All text in a drawing figure is hereby incorporated into the disclosure and is to be treated as part of the written description of the drawing figure.

The following claims are hereby incorporated into the disclosure, with each claim standing on its own as a separately claimed subject matter.

Although the description herein contains many details, these should not be construed as limiting the scope of the disclosure, but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. An apparatus for braking and vehicle control on a nonplanar road, the apparatus comprising:
a group of sensors comprising a road adherence sensor, a wheel speed sensor, a wheel angle sensor, and inputs on accelerator pedal, steering wheel and braking;
an inertial measurement unit (IMU) comprising one or more sensors configured to measure vehicle motion;
a vehicle actuator system comprising a distributed brake actuator system with independent actuation of brake torque at each independent wheel;
a controller configured to receive vehicle operational signals from said group of sensors and said IMU while outputting signals to the vehicle actuator system; and
wherein said controller determines friction cone and road contact constraints at fixed points in space in a multistage control sequence in a modeling a car as a body tangent to and in contact with a general parametric surface, with each stage of the control sequence being connected together with velocity constraints at adjacent stages capturing vehicle speed changing over time with allowed operating limits varying in response to road adherence changes to preemptively reduce vehicle speed by generating signals to the vehicle actuator system to actuate sufficient braking levels to maintain the vehicle in its lane.

2. The apparatus of claim 1, further comprising said actuator configured for controlling throttle actuation, and said controller configured for modulating throttle responses in combination with braking to preemptively reduce vehicle speed.

3. The apparatus of claim 1, further comprising said actuator configured for controlling steering actuation, and said controller configured for modulating steering responses in combination with braking toward maintaining the vehicle in its lane.

4. An apparatus for braking and vehicle control on a nonplanar road, the apparatus comprising:
a group of sensors comprising a road adherence sensor, a wheel speed sensor, a wheel angle sensor;
an inertial measurement unit (IMU) comprising one or more sensors configured to measure vehicle motion parameters, said vehicle motion parameters comprising one or more of vehicle linear acceleration, wheel rotational rate, and vehicle orientation;
a driver interface, said driver interface comprising one or more of an accelerator pedal, a brake pedal, a steering wheel, and one or more sensors associated with the accelerator pedal, brake pedal, and steering wheel;
a vehicle actuator system comprising a distributed brake actuator system with independent actuation of brake torque at each wheel and optionally at least one actuator selected from the group consisting of a steering actuator and a throttle actuator;
a controller configured to receive vehicle operational signals from said group of sensors, said IMU, said driver interface, said vehicle actuator system;
wherein said controller comprises a vehicle state detector, a brake distribution and actuation optimizer, a wheel state detector, a wheel traction calculator, a vehicle request detector, and a road adherence detector;
wherein said vehicle state detector outputs to said wheel traction calculator, wherein said wheel state detector outputs to said wheel traction calculator, wherein said road adherence detector outputs to said wheel traction calculator, wherein said vehicle state detector outputs to said brake distribution and actuation optimizer, wherein said wheel traction calculator outputs to said brake distribution and actuation optimizer, and wherein said vehicle request detector outputs to said brake distribution and actuation optimizer; and
wherein said brake distribution and actuation optimizer is configured to control operation of the vehicle actuator system as a function of said vehicle operational signals.

5. The apparatus of claim 4, further comprising a memory unit in the controller configured to output previously recorded or computed calibration and weight information to the wheel traction calculator.

6. The apparatus of claim 4:
wherein the controller constantly updates the wheel traction calculator to actively maintain maximum available braking and traction force information; and
wherein the brake distribution and actuation optimizer computes control signals and transmits the control signals to the brake actuator, and optionally to the steering actuator and the throttle actuator.

7. The apparatus of claim 4:
wherein said controller comprises a programmable processor and a non-transitory memory storing instructions executable by the processor; and
wherein said instructions perform the functions of said vehicle state detector, said brake distribution and actuation optimizer, said wheel state detector, said wheel traction calculator, said vehicle request detector, and said road adherence detector.

8. The apparatus of claim 4, wherein the controller performs steps comprising:
(a) measure proper vehicle acceleration (PVA) of the vehicle by reading the PVA from an inertial measurement unit (IMU), wherein PVA is vehicle acceleration without the effect of gravity;
(b) optionally, compute a compensation of the PVA based on dynamics effects such as vehicle weight and dynamic load;
(c) compute resultant net forces and moments being exerted where each wheel contacts a ground surface;
(d) measure or estimate the maximum road adherence at each wheel;
(e) measure speed and steering angle of each wheel;
(f) compute maximum available braking and traction force on each wheel;
(g) monitor general vehicle state to determine if there is a request for change from current state;
(h) enable optimized control logic in response to a request of state change, otherwise continue to monitor for state change requests;
(i) if a change is detected, first optionally account for external dynamic forces such as aerodynamic drag or tail wind, according to the input request type;
(j) compute a control signal to a vehicle actuation system based on a request for change and available brake and traction force as input;
(k) output at least a brake request for each independent wheel brake and optionally a request for a steering system and a propulsion system;
(l) determine if a deceleration is required at any wheel, either due to a request to brake (brake request) or due to a need to maintain steering such as computed via electronic stability control (ESC);
(m) calculate a brake force and a wheel slip request for each wheel, taking into account the previously computed brake force and traction as well as minimizing unrequested changes to the steering/angle of the vehicle, and outputting this distribution of braking force is to a brake controller that also maintains desired wheel slip on each wheel;
(n) if available and required, output a request to the propulsion system to increase, decrease, or apply negative throttle on all or a subset of a vehicle propulsion system; and
(o) if available and required, output a request to a steering controller or a driver steering indicator to alter steering of the vehicle to maintain the originally desired vehicle state change request.

9. An apparatus for predictive braking and vehicle control on a nonplanar road, the apparatus comprising:
a group of sensors comprising a road adherence sensor, an upcoming road geometry sensor, a wheel speed sensor, a wheel angle sensor;
an inertial measurement unit (IMU) comprising one or more sensors configured to measure vehicle motion parameters, said vehicle motion parameters comprising one or more of vehicle linear acceleration, wheel rotational rate, and vehicle orientation;
a driver interface, said driver interface comprising one or more of an accelerator pedal, a brake pedal, a steering wheel, and one or more sensors associated with the accelerator pedal, brake pedal, and steering wheel;
a vehicle actuator system comprising a distributed brake actuator system with independent actuation of brake torque at each wheel and optionally at least one actuator selected from the group consisting of a steering actuator and a throttle actuator;
a controller configured to receive vehicle operational signals from said group of sensors, said IMU, said driver interface, said vehicle actuator system;
wherein said controller comprises a vehicle state detector, a brake distribution and actuation optimizer, a wheel state detector, a wheel traction calculator, a vehicle request detector, and a road adherence detector;
wherein said vehicle state detector outputs to said wheel traction calculator, wherein said wheel state detector outputs to said wheel traction calculator, wherein said road adherence detector outputs to said wheel traction calculator, wherein said vehicle state detector outputs to said brake distribution and actuation optimizer, wherein said wheel traction calculator outputs to said brake distribution and actuation optimizer, and wherein said vehicle request detector outputs to said brake distribution and actuation optimizer;
wherein said brake distribution and actuation optimizer is configured to control operation of the vehicle actuator system as a function of said vehicle operational signals;
wherein said controller is configured to receive signals from the upcoming road geometry sensor; and
wherein said controller further comprises a safety planner that receives signals from the upcoming road geometry sensor, predicts a safest vehicle trajectory, and outputs correction requests to the vehicle request detector.

10. The apparatus of claim 9, further comprising a memory unit in the controller configured to output previously recorded or computed calibration and weight information to the wheel traction calculator.

11. The apparatus of claim 9:
wherein the controller constantly updates the wheel traction calculator to actively maintain maximum available braking and traction force information; and
wherein the brake distribution and actuation optimizer computes control signals and transmits the control signals to the brake actuator, and optionally to the steering actuator and the throttle actuator.

12. The apparatus of claim 9:
wherein said controller comprises a programmable processor and a non-transitory memory storing instructions executable by the processor; and
wherein said instructions perform the functions of said vehicle state detector, said brake distribution and actuation optimizer, said wheel state detector, said wheel traction calculator, said vehicle request detector, said road adherence detector, and said safety planner.

13. The apparatus of claim 9, wherein the controller performs steps comprising:
(a) measure proper vehicle acceleration (PVA) of the vehicle by reading the PVA from an inertial measurement unit (IMU), wherein PVA is vehicle acceleration without the effect of gravity;
(b) optionally, compute a compensation of the PVA based on dynamics effects such as vehicle weight and dynamic load;
(c) compute resultant net forces and moments being exerted where each wheel contacts a ground surface;
(d) measure or estimate the maximum road adherence at each wheel;
(e) measure speed and steering angle of each wheel;
(f) compute maximum available braking and traction force on each wheel;
(g) monitor general vehicle state to determine if there is a request for change from current state;
(h) enable optimized control logic in response to a request of state change, otherwise continue to monitor for state change requests;
(i) if a change is detected, first optionally account for external dynamic forces such as aerodynamic drag or tail wind, according to the input request type;
(j) compute a control signal to a vehicle actuation system based on a request for change and available brake and traction force as input;
(k) output at least a brake request for each independent wheel brake and optionally a request for a steering system and a propulsion system;
(l) determine if a deceleration is required at any wheel, either due to a request to brake (brake request) or due to a need to maintain steering such as computed via electronic stability control (ESC);
(m) calculate a brake force and a wheel slip request for each wheel, taking into account the previously computed brake force and traction as well as minimizing unrequested changes to the steering/angle of the vehicle, and outputting this distribution of braking force is to a brake controller that also maintains desired wheel slip on each wheel;
(n) if available and required, output a request to the propulsion system to increase, decrease, or apply negative throttle on all or a subset of a vehicle propulsion system; and
(o) if available and required, output a request to a steering controller or a driver steering indicator to alter steering of the vehicle to maintain the originally desired vehicle state change request.

14. A method for braking and vehicle control on a nonplanar road, the method comprising:
(a) measure proper vehicle acceleration (PVA) of the vehicle by reading the PVA from an inertial measurement unit (IMU), wherein PVA is vehicle acceleration without the effect of gravity;
(b) optionally, compute a compensation of the PVA based on dynamics effects such as vehicle weight and dynamic load;
(c) compute resultant net forces and moments being exerted where each wheel contacts a ground surface;
(d) measure or estimate the maximum road adherence at each wheel;
(e) measure speed and steering angle of each wheel;
(f) compute maximum available braking and traction force on each wheel;
(g) monitor general vehicle state to determine if there is a request for change from current state;
(h) enable optimized control logic in response to a request of state change, otherwise continue to monitor for state change requests;
(i) if a change is detected, first optionally account for external dynamic forces such as aerodynamic drag or tail wind, according to the input request type;
(j) compute a control signal to a vehicle actuation system based on a request for change and available brake and traction force as input;
(k) output at least a brake request for each independent wheel brake and optionally a request for a steering system and a propulsion system;
(l) determine if a deceleration is required at any wheel, either due to a request to brake (brake request) or due to a need to maintain steering such as computed via electronic stability control (ESC);
(m) calculate a brake force and a wheel slip request for each wheel, taking into account the previously computed brake force and traction as well as minimizing unrequested changes to the steering/angle of the vehicle, and outputting this distribution of braking force is to a brake controller that also maintains desired wheel slip on each wheel;
(n) if available and required, output a request to the propulsion system to increase, decrease, or apply negative throttle on all or a subset of a vehicle propulsion system; and
(o) if available and required, output a request to a steering controller or a driver steering indicator to alter steering of the vehicle to maintain the originally desired vehicle state change request.

15. A method for predictive braking and vehicle control on a nonplanar road with a safety planner, the method comprising:
(a) measure proper vehicle acceleration (PVA) of the vehicle by reading the PVA from an inertial measurement unit (IMU), wherein PVA is vehicle acceleration without the effect of gravity;
(b) optionally, compute a compensation of the PVA based on dynamics effects such as vehicle weight and dynamic load;
(c) compute resultant net forces and moments being exerted where each wheel contacts a ground surface;
(d) measure or estimate the maximum road adherence at each wheel;
(e) measure speed and steering angle of each wheel;
(f) compute maximum available braking and traction force on each wheel;
(g) monitor general vehicle state to determine if there is a request for change from current state;
(h) receive upcoming 3D road geometry information;
(i) predict how the vehicle will follow a reference trajectory over the upcoming road geometry;
(j) compute new state change requests to follow the reference trajectory while minimizing brake request changes, if necessary;
(k) enable optimized control logic in response to a request of state change, otherwise continue to monitor for state change requests;
(l) if a change is detected, first optionally account for external dynamic forces such as aerodynamic drag or tail wind, according to the input request type;
(m) compute a control signal to a vehicle actuation system based on a request for change and available brake and traction force as input;
(n) output at least a brake request for each independent wheel brake and optionally a request for a steering system and a propulsion system;
(o) determine if a deceleration is required at any wheel, either due to a request to brake (brake request) or due to a need to maintain steering such as computed via electronic stability control (ESC);
(p) calculate a brake force and a wheel slip request for each wheel, taking into account the previously computed brake force and traction as well as minimizing unrequested changes to the steering/angle of the vehicle, and outputting this distribution of braking force is to a brake controller that also maintains desired wheel slip on each wheel;
(q) if available and required, output a request to the propulsion system to increase, decrease, or apply negative throttle on all or a subset of a vehicle propulsion system; and
(r) if available and required, output a request to a steering controller or a driver steering indicator to alter steering of the vehicle to maintain the originally desired vehicle state change request.
